(19) United States
(12) Patent Application Publication
(10) Pub. No.: US 2017/0316159 A1
(43) Pub. Date: Nov. 2, 2017

(54) System And Method For Updating Customer Data

(71) Applicant: Veeva Systems Inc., Pleasanton, CA (US)

(72) Inventor: Jessie Hooker, Toronto (CA)

(73) Assignee: Veeva Systems Inc., Pleasanton, CA (US)

(21) Appl. No.: 15/139,697

(22) Filed: Apr. 27, 2016

(51) Int. Cl. G06F 19/00

(52) U.S. Cl. CPC G06F 19/322

(57) ABSTRACT

Systems and methods for processing user requests for updating a customer data storage system. Administrative users may configure automatic approval of the type of HCP. When a new record belonging to the type of HCP is added, the request may be automatically approved without being reviewed by the customer's local data steward.

### BACKGROUND

The subject technology relates generally to customer data management.

In the pharmaceutical sales industry, sales representatives visit, call or send emails to doctors to communicate product information. Their company employers (e.g., pharmaceutical companies) often use a customer data storage system to manage the doctors' professional information and make such information available to sales representatives. It is desirable to update data in the customer data storage system efficiently.

### SUMMARY

The disclosed subject matter relates to a method for processing user requests for updating a customer data storage system. The method comprises: receiving a command for enabling automatic approval of a request for adding a record as a first type of healthcare provider (“HCP”) to the customer data storage system, wherein the customer data storage system stores master data managed by a master data management (“MDM”) system and non-master data, and wherein the non-master data comprises customer owned records compiled by a customer. The method further comprises: receiving a first request for adding a first new record as the first type of healthcare provider; checking the customer owned records to determine if there is a match for the first new record; creating an add request when there is not a match in the customer owned record for the first new record; determining that automatic approval is enabled for adding a new record as the first type of healthcare provider; and storing the first new record to the customer data storage system as a customer owned record.

### BRIEF DESCRIPTION OF THE DRAWINGS

FIG. 1 illustrates an example high level block diagram of an enterprise data management architecture wherein the present invention may be implemented.

FIG. 2 illustrates an example high level block diagram of a computing device.

FIG. 3 illustrates an example high level block diagram of an MDM server according to one embodiment of the present invention.

FIG. 4 illustrates an example user interface for an administrative user to configure automatic approval workflow according to one embodiment of the present invention.

FIG. 5 illustrates an example flowchart of a method for adding a new record to the customer data storage system according to one embodiment of the present invention.

FIG. 6 illustrates an example flowchart of a method for updating an existing record in the customer data storage system according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

The subject technology is directed to techniques for managing, integrating and synchronizing data for an enterprise. A customer data storage system and a Master Data Management (“MDM”) system may be used to hold and manage the enterprise's data. The MDM system may store customer master data for the enterprise, which may include data from an MDM provider. A data steward service may be used to maintain the customer master data in the MDM and make it accurate and up-to-date. The customer data storage system may store customer data. e.g., account information, for the enterprise. Data in the customer data storage system may include those managed by the MDM system (“master data” or “master record”, e.g., account, address and child account) and those not (“non-master data”). Non-master data may include records compiled by a customer (“customer owned records”) and records provided by a third party (“third party records”). The customer may use a local data steward to maintain the customer owned records. The customer data storage system may be a customer relationship management (“CRM”) system, and its master data may be synchronized with the MDM system regularly.

A data change request (“DCR”) may be generated when a data change in the CRM system may involve master data. A DCR may be a separate and independent object, and may be used for all data changes including, e.g., new record creation, modification of existing record, and deletion of existing record. A DCR may be generated for each separate master data object (e.g., account, address or child account) that is created or edited. A DCR may also be generated for changes to two or more related objects.

Each DCR may have one or more DCR lines. A DCR line may be generated for each data field change and may include a DCR line ID, and the data field's name, old value, new value, final value and validation result. The verification result may include accepting the requested data change, rejecting the requested data change, and partially accepting the requested data change. The final verification result may be populated after the data change is successfully verified in the MDM system.

When a user requests to add a new account for an individual (e.g., a doctor) to the MDM system, a data change request may be sent to the MDM system so that the data steward can verify information of the new account. Around the time the DCR is created, an under review account for the individual may be created in the customer data storage system to allow the user to record interactions with the under review account before verification of the account information in the MDM system is completed. If the account information is correct, the requested data change for the under review account may be accepted into the MDM, and then update the customer data storage system.

A user may request to add or change a customer record. An administrative user may enable automatic approval for a healthcare provider (“HCP”) type or healthcare organization (“HCO”) type. When the customer record to be added or changed belongs to that HCP or HCO type, the data change may be approved automatically without being reviewed by the customer's local data steward. The automatic approval may be configured country by country.

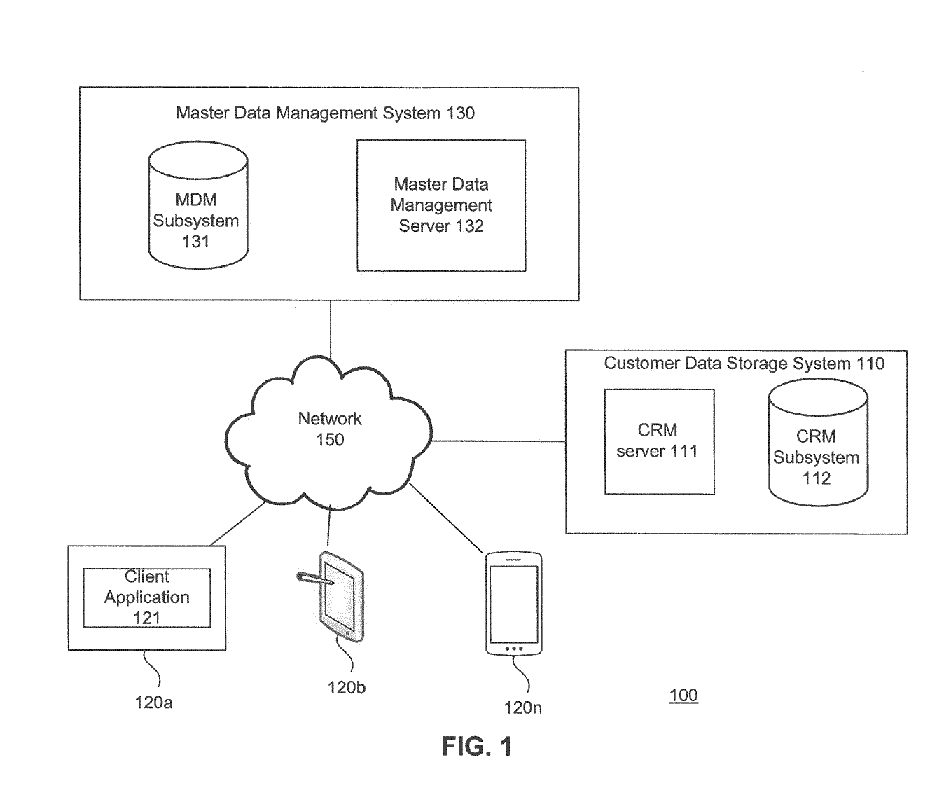

FIG. 1 illustrates an example high level block diagram of an enterprise data management architecture 100 wherein the present invention may be implemented. The enterprise may be a business, or an organization. As shown, the architecture 100 may include a customer data storage system 110, a plurality of user computing devices 120a, 120b, . . . 120n, and an MDM system 130, coupled to each other via a network 150. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 120a-120n may be any machine or system that is used by a user to access the CRM 110 and the MDM 130 via the network 150, and may be any commercially available computing devices including laptop computers, desktop computers, mobile phones, smart phones, tablet computers, netbooks, and personal digital assistants (PDAs). A client application 121 may run from a user computing device, e.g., 120a, and access data in the MDM 130 and the customer data storage system 110 via the network 150.

In one implementation, the customer data storage system 110 may be a CRM system. The CRM system may have a CRM server 111 and a CRM subsystem 112. The CRM server 111 is typically a remote computer system accessible over a remote or local network, such as the network 150. A client application (e.g., 121) process may be active on one or more user computing devices 120a-120n, and the corresponding server process may be active on the CRM server 111. The client application process and the corresponding server process may communicate with each other and with the master data management 130 over the network 150, thus providing distributed functionality and allowing multiple client applications to take advantage of the information-gathering capabilities of the CRM 110 and the MDM 130.

The CRM subsystem 112 may store data that client applications (e.g., 121) in user computing devices 120a-120n may use. In one embodiment, the CRM subsystem 112 may store data that pharmaceutical companies may need when promoting new products, which may include physician professional information (e.g., name, specialty, license information, affiliated HCO, contact information at the affiliated HCO, prior interaction record, electronic signature for samples, and medical inquiry submission), product information (e.g., name, category, lot and statistics), sales representative information (e.g., name, territory information, sharing rules and sales reports). It should be understood that the CRM subsystem 112 may store data for other industries. Data in the CRM subsystem 112 may include master data managed by the MDM 130 and non-master data, and the non-master data may include customer owned records and third party records.

The MDM 130 may include an MDM subsystem 131 and an MDM server 132. The MDM subsystem 131 may store customer master data which may be provided by an MDM provider. The customer master data may be many types of data which may be used by the enterprise, e.g., accounts, addresses and reference data. In one implementation, the MDM subsystem 131 may store verified HCP and/or HCO information for a pharmaceutical company, as the customer. In one example, the MDM subsystem 131 may store verified physician professional information of cardiologists in the U.S. compiled and/or purchased by a pharmaceutical company. Each HCP may be an account in the MDM subsystem 131. Master data (e.g., account, address and child account) managed by the MDM 130 may also be stored in DCR-controlled fields in the CRM subsystem 112.

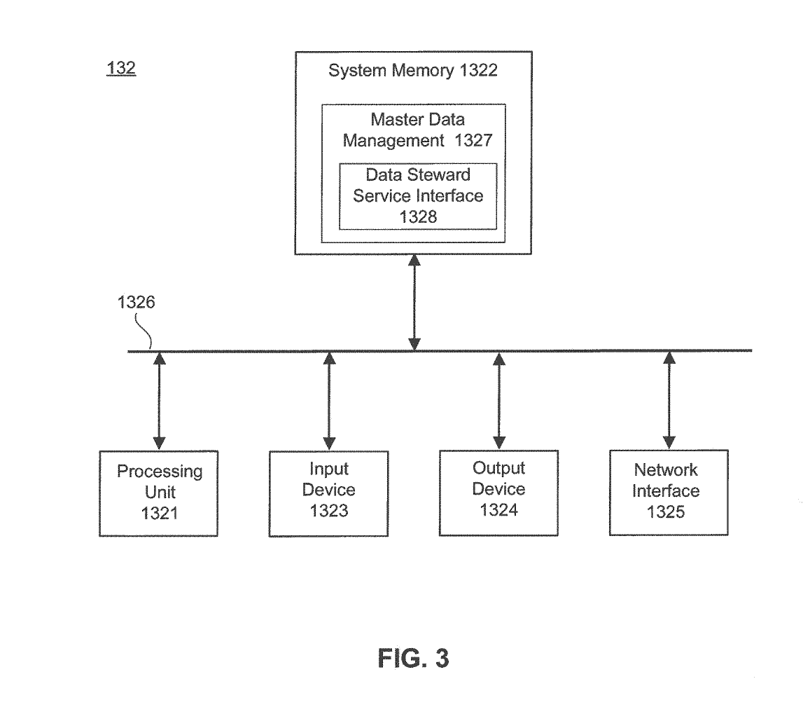

The master data management server 132 may be used to cleanse, standardize and/or de-duplicate data from different sources to form the single, consolidated customer master data and store the customer master data in the MDM subsystem 131. This may help the enterprise to avoid using multiple and potentially inconsistent versions of the same data. Any changes to the customer master data will be displayed on the data steward interface 1328 shown in FIG. 3, so that a data steward may check the changes and update the customer master data when the changes are verified. The master data management server 132 may further notify the customer data storage system 110 about any updated accounts, so that the customer data storage system 110 may be updated with the changes.

In one implementation, the MDM 130, including the customer master data in the MDM subsystem 131, may be provided to the customer by an MDM provider as a software as a service (“SaaS”). In addition, like the CRM 110, the MDM 130 may be a cloud based multi-tenant system.

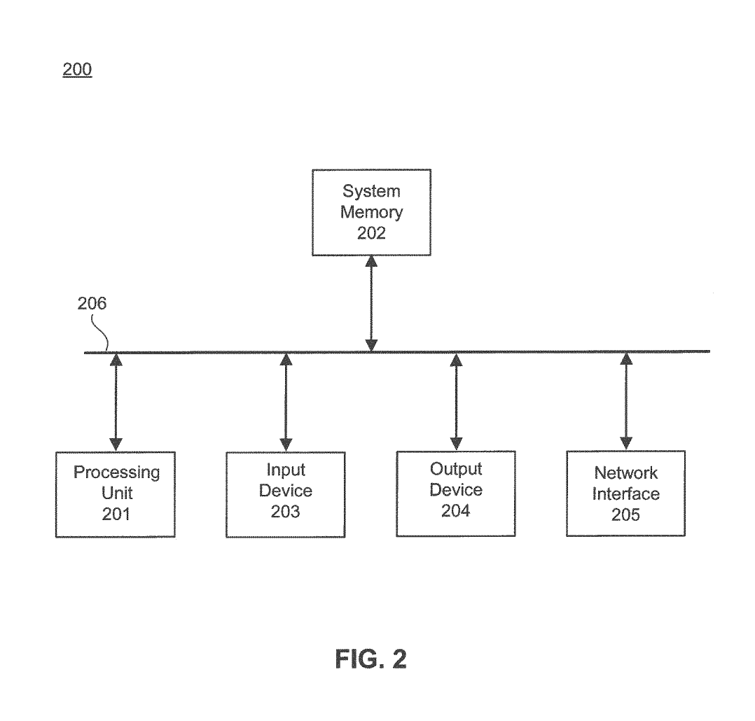

FIG. 2 illustrates an example high level block diagram of a computing device 200 which can be used as the user computing devices 120a-120n, the master data management server 132, and/or the CRM server 111 in FIG. 1. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, but not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 204 which may be, e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 205 may include one or more network interface cards (NICs).

FIG. 3 illustrates an example high level block diagram of the master data management server 132. The master data management server 132 may be implemented by the computing device 200, and may have a processing unit 1321, a system memory 1322, an input device 1323, an output device 1324, and a network interface 1325, coupled to each other via a system bus 1326. The system memory 1322 may store a master data management module 1327, which may be used to cleanse, standardize and de-duplicate HCP and/or HCO data from various sources to form the single, consolidated customer master data.

The master data management module 1327 may control a data steward service interface 1328, which may display records to be verified, merged or updated, receive updates to the customer master data, and store the updates to the MDM subsystem 131.

The pharmaceutical companies may purchase service from an MDM provider to use the MDM 130, including the customer master data in the MDM subsystem 131. In one implementation, the MDM subsystem 131 may store address and license information of all physicians in a state, or all physicians with a specialty.

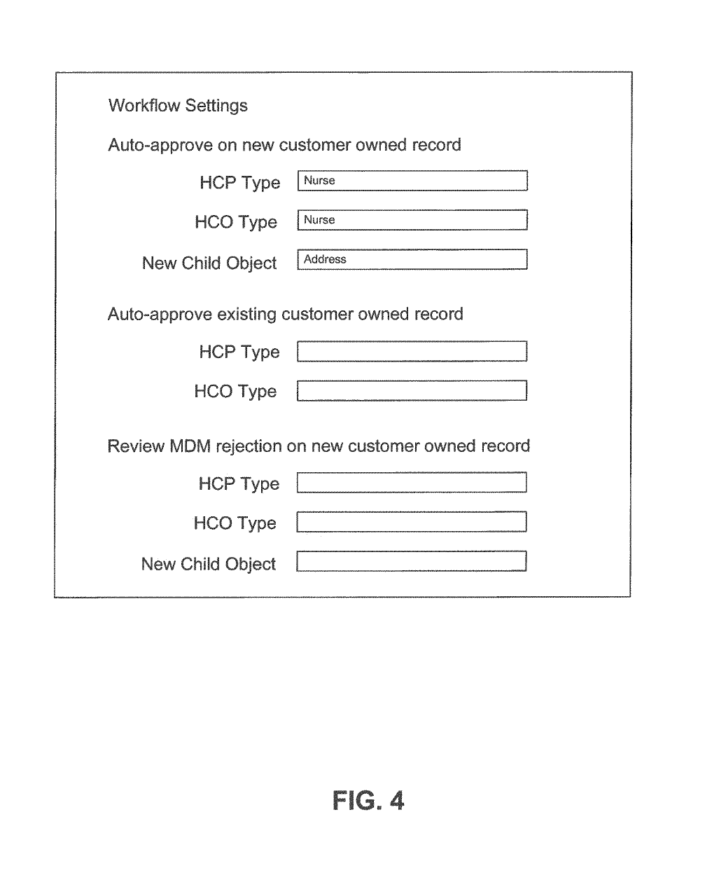

FIG. 4 illustrates an example user interface for an administrative user to configure automatic approval workflow according to one embodiment of the present invention. As shown, the administrative user may enable automatic approval of requests for adding certain types of new records to the customer owned records, e.g., HCP type and HCO type. The administrative user may select the type of new record to be automatically approved from a picklist in a pull-down or a pop-up window. In one implementation, the HCP type may include, e.g., business professional, dentist, doctor, nurse, pharmacist, resident, and student. In one example, automatic approval of requests for adding new records for nurses to the customer owned records may be enabled.

The administrative user may also enable automatic approval of requests for changing certain types of existing customer owned records, e.g., HCP type and HCO type. The administrative user may select the type of existing customer owned record to be automatically approved from a picklist in a pull-down or a pop-up window. In one implementation, the HCP type may include, e.g., business professional, dentist, doctor, nurse, pharmacist, resident, and student. In one example, automatic approval of requests for changing existing customer owned records for nurses may be enabled.

In one implementation, the administrative user may enable automatic approval of the MDM 130's rejections of adding requests and changing requests for, e.g., an HCP type or HCO type. For example, a request to add Jane Smith as a nurse was rejected by the MDM 130. If the automatic approval of rejection of adding request for nurses is enabled, the rejection will not be reviewed by the customer's local data steward. Otherwise, the rejection may be reviewed by the customer's local data steward.

In one implementation, the automatic approval of adding requests, changing requests and rejections may be configured by country. In one example, an adding request for a nurse may be set up to be automatically approved in the U.S., but to be reviewed by the customer's local data stewards in Europe.

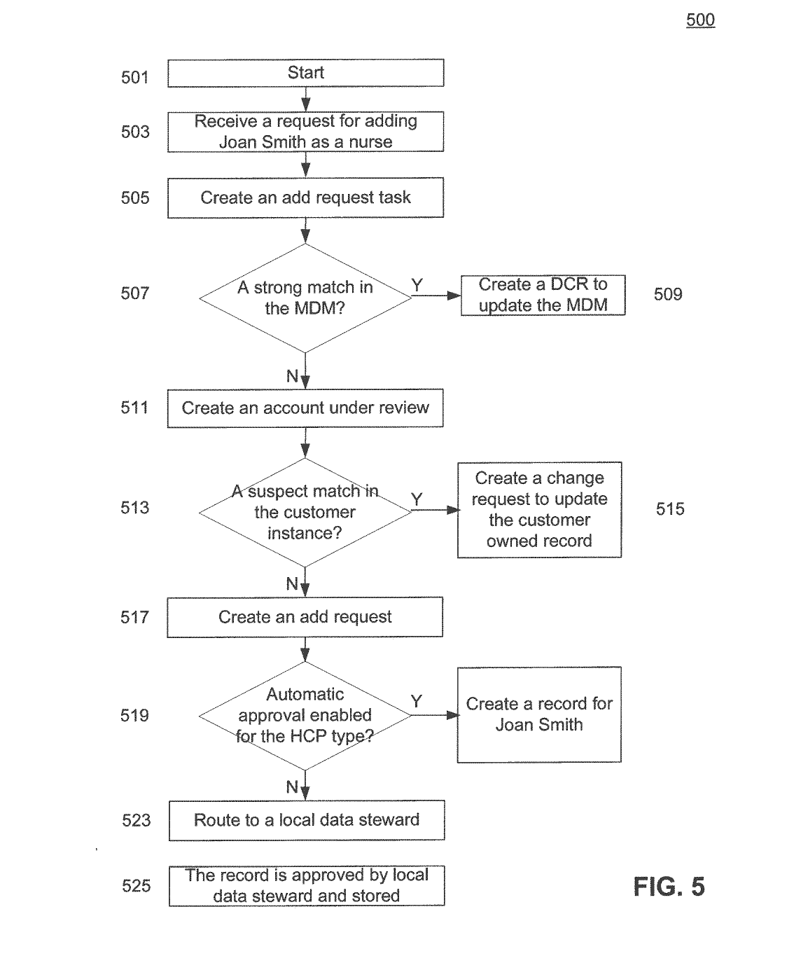

FIG. 5 illustrates an example flowchart of a method for adding a new record to the customer data storage system according to one embodiment of the present invention. The process may start at 501.

At 503, a request for adding a new record for Joan Smith as a nurse may be received at the customer data storage system 110.

At 505, an add request task may be created.

At 507, it may be determined if a strong match for Joan Smith is found in the MDM 130.

If yes, at 509, a DCR may be created to update the existing record in the MDM 130 with new information of Joan Smith. A DCR may be created and sent to the MDM 130 for verification. For each account, one DCR may be generated. Each DCR may contain one or more DCR lines. Each DCR line may represent a single field value change request, and may include the field, old value, new value, final value and verification result from the MDM 130. The DCR may be verified in the MDM 130. In one implementation, a data steward may verify the account information in the DCR from the user. If the account information in the DCR is correct, the DCR may be accepted in the MDM 130. If the account information in the DCR is wrong, the DCR may be rejected by the MDM 130.

If there is no strong match in the MDM 130, an under review account may be created at 511 for Joan Smith in the CRM 110, so that the user may act immediately to perform transactional actions on the under review account (e.g., creating calls or recording interactions with the under review account) without having to wait for the verification result from the MDM 130. The special status “Under Review” may be used to differentiate it from verified data. To remind users that an account is an under review account and the account information is waiting to be verified, the UI for an under review account may be displayed differently from the verified accounts. In one example, a label “Under Review” may be displayed to mark the account as an under review account. Alternatively, the nurse's name may be shadowed to indicate that the account is an under review account.

At 513, an automatic match may be performed to see if there is any Joan Smith in the customer instance, i.e., the customer data storage system, already.

If there is one, at 515, a change request may be created to update the existing customer owned record with new information of Joan Smith.

If there is not a match in the customer instance, at 517, an add request may be created.

At 519, it may be determined if automatic approval is enabled for nurse, the HCP type.

If yes, at 521, a normal valid record may be created for Joan Smith, as a nurse, and made available to the customer as a customer owned record in the customer data storage system, without involving the customer's local data steward.

If automatic approval is not enabled, at 523, the add request may be routed to the customer's local data steward for review.

If the customer's local data steward approves the add request, at 525, a customer owned record may be stored in the customer data storage system for Joan Smith, a nurse.

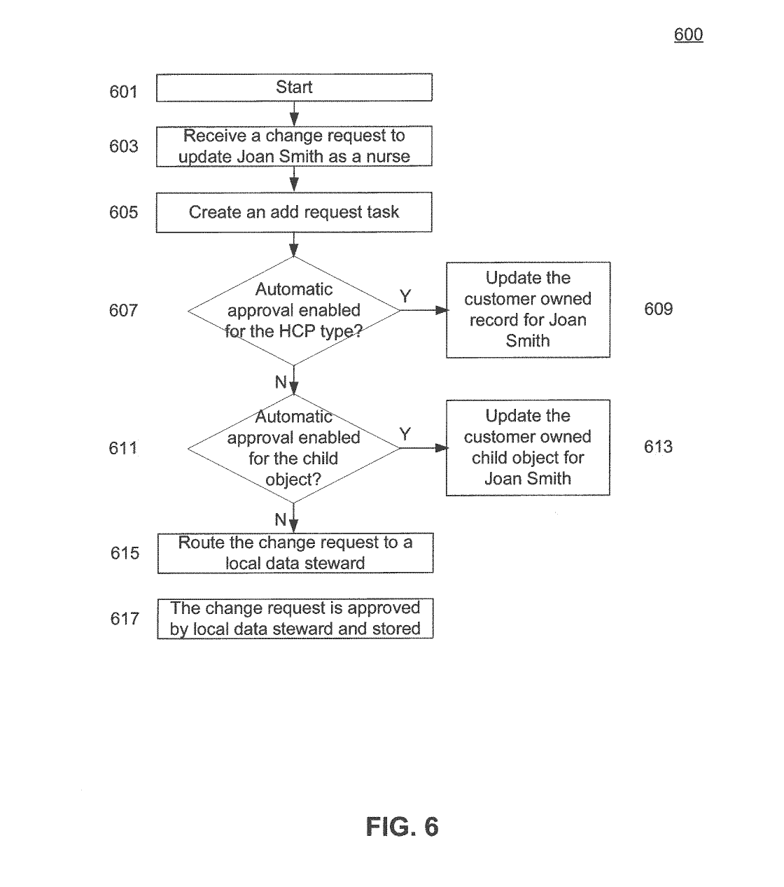

FIG. 6 illustrates an example flowchart of a method for updating a record in the customer data storage system according to one embodiment of the present invention. The process may start at 601.

At 603, a change request may be received to update an existing customer owned record for Joan Smith, a nurse. The change request may be used to update the address, phone, parent HCO relationship which is the affiliation, or license information of Joan Smith.

At 605, a change request task may be created.

At 607, it may be determined if automatic approval is enabled for nurse, the HCP type.

If yes, at 609, the customer owned record for Joan Smith may be updated without involving the customer's local data steward.

If automatic approval is not enabled for this HCP type, at 611, it may be determined if the child object (e.g., address, phone, parent HCO relationship which is the affiliation, license), is enabled for automatic approval.

If yes, that child object may be updated in the existing customer owned record at 613.

If the child object is not enabled for automatic approval, the change request may be routed to the customer's local data steward at 615.

At 617, the customer owned record may be updated when the customer's local data steward approves the change request.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer” “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

What is claimed is:

1. A method for processing user requests for updating a customer data storage system, the method comprising:
receiving a command for enabling automatic approval of a request for adding a record as a first type of healthcare provider (“HCP”) to the customer data storage system, wherein the customer data storage system stores master data managed by a master data management (“MDM”) system and non-master data, and wherein the non-master data comprises customer owned records compiled by a customer;
receiving a first request for adding a first new record as the first type of healthcare provider;
checking the customer owned records to determine if there is a match for the first new record;
creating an add request when there is not a match in the customer owned record for the first new record;
determining that automatic approval is enabled for adding a new record as the first type of healthcare provider; and
storing the first new record to the customer data storage system as a customer owned record.

2. The method of claim 1, wherein the first type of healthcare provider is selected from the group consisting of nurse, physician, business professional, pharmacist and dentist.

3. The method of claim 1, further comprising: when automatic approval is not enabled for adding a new record as the first type of healthcare provider, routing the add request for manual review.

4. The method of claim 1, further comprising: when there is an existing customer owned record matching the first new record, creating a change request to update the existing customer owned record.

5. The method of claim 1, further comprising: determining if there is an existing MDM record matching the first new record.

6. The method of claim 5, further comprising: when there is an existing MDM record matching the first new record, creating a data change request to update the existing MDM record.

7. The method of claim 5, further comprising: creating an under review account for the first new record in the customer data storage system when there is not an existing MDM record matching the first new record.

8. The method of claim 1, further comprising: receiving a change request to update an existing customer owned record.

9. The method of claim 8, further comprising: determining that automatic approval is enabled for changing an existing customer owned record as the first type of healthcare provider, and updating the existing customer owned record.

10. The method of claim 8, further comprising: determining that automatic approval is enabled for changing a child object of the existing customer owned record as the first type of healthcare provider, and updating the child object.

11. A customer data storage system, comprising a controller for:
receiving a command for enabling automatic approval of a request for adding a record as a first type of healthcare provider (“HCP”) to the customer data storage system, wherein the customer data storage system stores master data managed by a master data management (“MDM”) system and non-master data, and wherein the non-master data comprises customer owned records compiled by a customer;
receiving a first request for adding a first new record as the first type of healthcare provider;
checking the customer owned records to determine if there is a match for the first new record;
creating an add request when there is not a match in the customer owned record for the first new record;
determining that automatic approval is enabled for adding a new record as the first type of healthcare provider; and
storing the first new record to the customer data storage system as a customer owned record.

12. The system of claim 11, comprising a customer relationship management (“CRM”) system.

13. The system of claim 11, wherein the customer master data is synchronized with the MDM regularly.

14. The system of claim 11, wherein the controller further: routes the add request for manual review when automatic approval is not enabled for adding a new record as the first type of healthcare provider.

15. The system of claim 11, wherein the controller further: creates a change request to update the existing customer owned record when there is an existing customer owned record matching the first new record.

16. The system of claim 11, wherein the controller further: determines if there is an existing MDM record matching the first new record.

17. The system of claim 16, wherein the controller further: creates a data change request to update the existing MDM record when there is an existing MDM record matching the first new record.

18. The system of claim 16, wherein the controller further: creates an under review account for the first new record when there is not an existing MDM record matching the first new record.

19. The system of claim 11, wherein the controller further: receives a change request to update an existing customer owned record.

20. The system of claim 11, wherein the controller further: determines that automatic approval is enabled for changing an existing customer owned record as the first type of healthcare provider, and updates the existing customer owned record.
